(19) United States
(12) Patent Application Publication
(10) Pub. No.: US 2022/0290004 A1
(43) Pub. Date: Sep. 15, 2022

(54) REPELLENT COATINGS FOR HIGH TEMPERATURE SURFACES

(71) Applicant: SpotLESS Materials Inc., State College, PA (US)

(72) Inventors: Nan SUN, State College, PA (US); Birgitt BOSCHITSCH, State College, PA (US); Tak-Sing WONG, State College, PA (US)

(21) Appl. No.: 17/691,419

(22) Filed: Mar. 10, 2022

Related U.S. Application Data
(63) Continuation of application No. PCT/US2022/019660, filed on Mar. 10, 2022.
(60) Provisional application No. 63/159,208, filed on Mar. 10, 2021.

(51) Int. Cl. C09D 183/06; C09D 5/18; C09D 7/65; B08B 17/02; B05D 3/02

(52) U.S. Cl. CPC C09D 183/06; C09D 5/18; C09D 7/65; B08B 17/02; B05D 3/0209

(57) ABSTRACT

Repellent coatings for solid surfaces that repeatedly are subjected to high temperatures cycles are disclosed. The repellent coatings on such surfaces are formed from a formulation having (i) one or more reactive silane or siloxane components that can form a bonded layer on the surface in which the bonded layer comprises an array of compounds each compound having one end bound to the surface and an opposite end extending away from the surface, (ii) an acid catalyst, and (iii) a solvent. A lubricant can be included in the formulation or applied on a formed bonded layer. The surface of the substrate and repellent coating thereon are subjected to a temperature of above and below 65° C. as a cycle and the cycle repeated at least twice.

### CROSS-REFERENCE TO RELATED APPLICATION

This application is a continuation of International Application No. PCT/US2022/019660, filed 10 Mar. 2022, which claims the benefit of U.S. Provisional Application No. 63/159,208 filed 10 Mar. 2021, the entire disclosures of each of which is hereby incorporated by reference herein.

### TECHNICAL FIELD

The present invention relates to formulations and use thereof to form repellent coatings on surfaces of substrates that experience a wide range of temperatures including high temperatures such as temperatures above 65° C.

### BACKGROUND

Repellent coating formulations are known. See for example, Wang, et al., “Covalently Attached Liquids: Instant Omniphobic Surfaces with Unprecedented Repellency”, Angewandte Chemie International Edition 55, 244-248 (2016); WO 2018/094161; WO 2019/222007 and WO 2021/051036.

Several references disclose thermally stable crosslinked siloxanes for surface coatings. See Urate et al., “A thermally stable, durable and temperature-dependent oleophobic surface of a polymethylsilsesquioxane film”, Chem Comm 49: 3318 (2013); U.S. Pat. No. 10,138,380.

However, there is a continuing need to develop repellent surface coatings that are simple to apply and environmentally acceptable and there is a continuing need to develop repellent surface coatings that are simple and rapid to apply and maintain repellency after exposure to high temperatures.

### SUMMARY OF THE DISCLOSURE

Advantages of the present disclosure include formulations and processes to prepare repellent coatings for solid surfaces that repeatedly are subjected to high temperatures. Such surfaces can be composed of ceramics, glasses, glass-ceramics, porcelain, metals, alloys, high temperature stable polymers, composites or combinations thereof.

The formed repellent coatings are slippery and can repel and reduce adhesion to liquids, viscoelastic materials (e.g., viscoelastic semi-solids and solids), solids, burnt residue from spilled food stuffs and can further resist staining. In addition, repellent coatings on surfaces of substrates as disclosed herein are thermally stable and can undergo repeated high temperature cycling and maintain repellency through such cycling.

These and other advantages are satisfied, at least in part, by a substrate comprising a repellent coating on a surface thereof, in which the surface of the substrate and repellent coating thereon are subjected to a temperature of above and below 65° C. as a high temperature cycle and the cycle repeated multiple times such as at least twice, e.g. repeating the cycle at least 3, 4, 5, 6, 7, 8, 9 10, 50, 100, 200, etc. times. Advantageously, the surface of the substrate and repellent coating thereon can be subjected to a temperature of above and below 100° C. as a high temperature cycle and the cycle repeated multiple times.

Other aspects of the present disclosure include process of forming and using a repellent coating on a surface of a substrate by subjecting the surface of the substrate and repellent coating thereon to a temperature of above and below 65° C., such as above and below 100° C., as a high temperature cycle and repeating the high temperature cycle, e.g. repeating the cycle at least 3, 4, 5, 6, 7, 8, 9 10, 50, 100, 200, etc. times. The repellent coating on the surface of the substrate can be formed by drying a formulation on a surface of a substrate to substantially remove a solvent and to form a repellent coating on the surface; and after forming the repellent coating, subjecting the surface of the substrate and repellent coating thereon to high temperature cycling. Advantageously, applying the formulation and/or drying can be carried out in air and/or at atmospheric pressure and/or at temperatures below about 40° C.

A further aspect of the present disclosure includes using substrates having a repellent coating on the surface thereof by subjecting the surface of the substrate and repellent coating thereon to a temperature of above 100° C., e.g., above 100° C. to about 300° C., for at least 10 minutes, such as at least 20 minutes, 30 minutes, etc. The substrate having a repellent coating on the surface thereof can further be used by subjecting the surface of the substrate and repellent coating thereon to high temperature cycling. After repeated high temperature cycling, the surface having the repellent coating can have an average sliding contact angle for a 20 μL water droplet of no more than about 35°, such as no more than about 30°, 25°, 20°, etc. when measured at 20° C.

Another aspect of the present disclosure includes processes for cleaning and forming repellent coatings on a surface of a substrate by applying formulations of the present disclosure on the surface to remove debris and/or residue thereon. The formulations can be applied under pressure (e.g., greater than 101 kPa, such as greater than 200 or 300 kPa) and under heat (e.g., greater than 35° C. such as from 35° C. to about 100° C.), which is advantageous in closed systems such as in heat exchangers and tanks. The formulations can also be circulated in a device with surfaces for cleaning and coating, with or without heat and/or pressure, which is advantageous in closed systems. The applied formulation, with or without additional formulation, can then be dried to substantially remove the solvent and to form the repellent coating on the cleaned surface.

In some embodiments, the formulation applied to the surface of the substrate to form a repellent coating thereon can comprise: (i) one or more reactive components that can form a bonded layer on a surface in which the bonded layer comprises an array of compounds having one end bound to a surface and an opposite end extending away from the surface, (ii) an acid catalyst, (iii) a solvent, and optionally (iv) a lubricant. The one or more reactive components of the formulations of the present disclosure can include, for example, low molecular weight silanes or siloxanes that have one or more hydrolysable groups. Such silanes or siloxanes can have a molecular weight of less than about 1,500 g/mol such as less than about 1,000 g/mol and can include, for example, alkoxysilanes, di-alkoxy silanes, tri-alkoxy silanes or combinations thereof. In certain embodiments, the array of compounds and/or polymers formed from the reactive compounds are not crosslinked. Acid catalysts can include sulfuric acid, hydrochloric acid, phosphoric acid, nitric acid, benzoic acid, acetic acid, ascorbic acid, citric acid, formic acid, lactic acid, oxalic acid, or combinations thereof. Solvents can include a lower ketone, a lower alcohol, a lower ether, a lower ester, a lower halogenated solvent and combinations thereof. In some embodiments, the solvent is a non-volatile organic compound, which can include non-cyclic, low molecular weight siloxanes. Lubricants can include a silicone oil or a mineral oil or any combination thereof.

The repellent coating can be formed on a wide variety of surface compositions including ceramics, glasses, glass-ceramics, porcelains, metals, alloys, and combinations thereof that are subjected to high temperatures such as surfaces of induction and radiant cooktops and stoves and other cooking surfaces, ovens as well as tanks, containers, heat exchangers, such as heat exchangers for processing foods and beverages, etc.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIG. 1 is a plot showing water sliding angles of substrates having a repellent coating thereon as a function of high temperature cycles.

FIG. 2 is a plot showing water sliding angles of substrates having a repellent coating thereon as a function of high temperature (after baking at different temperatures for 60 minutes).

FIGS. 3A and 3B are plots showing water sliding angles of substrates having a repellent coating thereon and with and without a protective cover as a function of high temperature (after baking at different temperatures for 60 minutes).

### DETAILED DESCRIPTION OF THE DISCLOSURE

The present disclosure relates to substrates that are subjected to high temperature cycles comprising a repellent coating on a surface thereof. For example, the surface of the substrate and repellent coating thereon can be subjected to temperatures of above and below 65° C., such as above and below 100° C., as a high temperature cycle. In one aspect of the present disclosure a high temperature cycle can include the surface of the substrate and repellent coating thereon subjected to temperatures of above 65° C., such as above 100° C., to about 280, e.g., about 300° C. as a first part of the cycle and then subjected to a temperature below 300° C., below 280° C. , such as below 100° C. and below 65° C. to about 20° C. or about −50° C. as the second part of the high temperature cycle. The high temperature cycles can be repeated multiple times such as at least twice, e.g. repeating the cycle at least 3, 4, 5, 6, 7, 8, 9 10, 50, 100, 200, etc. times.

Devices having substrate surfaces subject to high temperature cycles include, for example, induction and radiant cooktops and stoves and other cooking surfaces and cookware and ovens as well as tanks, containers, heat exchangers, such as heat exchangers for processing foods and beverages, etc. The substrate surfaces for such devices can be composed of ceramics, glasses, glass-ceramics, porcelains, metals, alloys, composites or combinations thereof. Other substrate surfaces can be composed of polymers and high temperature stable polymers and composites thereof.

Repellent coatings on surfaces of substrates as disclosed herein are thermally stable such that the repellent coating on the surface of the substrate can be maintained at a temperature of above 100° C., e.g., above 100° C. to about 300° C., for at least 10 minutes, such as at least 20 minutes, 30 minutes, etc. For example, the surface having the repellent coating can have an average (at least three independent measurements) sliding contact angle for a 20 μL water droplet of no more than about 35°, such as no more than about 30°, 25°, 20 °, etc. and even less than about 10° when measured at 20° C., after the surface was subjected to a high temperature and/or repeated high temperature cycling. If the surface of the substrate being tested has features or roughness or otherwise would interfere with the sliding contact angle measurement, then a surface substrate composed of the same composition and subjected to the same high temperature and/or repeated high temperature cycling that is smooth (i.e., has an average surface roughness Ra of less than about 1 μm) such that it does not interfere with the sliding angle measurement can be substituted for the surface substrate with the features to remove artifacts caused by the features.

Repellent coatings on surfaces of substrates as disclosed herein can be formed from a formulation that includes: (i) reactive component(s) to form a bonded layer on the surface of a substrate; (ii) acid catalyst(s); (iii) solvent(s); and optionally (iv) lubricant(s). The reactive component(s) of the formulation are used to form the bonded layer onto the surface of a substrate by allowing them to react with the surface to form an array of compounds on the surface in which each compound has one end covalently bound to the surface and an opposite end extending away from the surface. As such, the bonded layer resembles a brush with linear chains bound to the surface. The acid catalyst facilitates and accelerate formation of the bonding layer at a reduced time and temperature and the solvent can also facilitate formation of the bonding layer. An optional lubricant layer can be stably adhered to the bonded layer primarily through van der Waals interactions to enhance the repellent coating. The lubricant used to form the lubricant layer can be included in the initial formulation applied to the substrate surface or applied after formation of the bonded layer on the substrate. In either case, the lubricant preferably forms a lubricant layer that is stably adhered to the bonded layer. In an aspect of the present disclosure, the formulation includes the optional lubricant. Such a formulation can form a repellent coating comprising a bonded layer with a lubricant layer stably adhered to the bonded layer as an all-in-one formulation.

The bonded layer can be formed directly or indirectly on a surface of a substrate by reacting the reactive components of the formulation directly with functional groups, e.g., hydroxyl groups, acid groups, ester groups, etc., which are directly on the surface of the substrate. Such functional groups can be naturally present or induced on the substrate such as by treating the surface with oxygen/air plasma or by heating under the presence of air or oxygen, etc.

Useful reactive components for formulations of the present disclosure include, for example, reactive components that have one end that bonds to the substrate surface, e.g., covalently bonds to one or more reactive groups on the surface, to form an assembly of compounds. Such reactive components preferably have a chain length of at least 3 carbons. Other useful reactive components include polymerizable monomers that can react to form an array of linear polymers having ends anchored to the surface and opposite ends extending away from the surface. To increase the speed of forming a coating, the reactive components of the formulation are selected to undergo a condensation reaction with loss of a small molecule such as water, an alcohol, etc., which can be readily removed to drive the reaction to more or less completion under ambient temperatures and pressures. Preferably the linear polymers, with one end attached to the surface and the other extending away from the surface, do not form covalent bonds with the adjacent linear polymers or crosslink such as crosslink with the adjacent linear polymers (e.g., the linear polymers form a brush-like structure). A lack of crosslinking allows the chains and ends extending away from the surface higher mobility to further enhance the repellency of the repellent coating system.

Useful reactive components for formulations of the present disclosure include, for example, low molecular weight silanes or siloxanes that have one or more hydrolysable groups. Such silanes or siloxanes have a molecular weight of less than about 1,500 g/mol such as less than about 1,000 g/mol and include a monoalkyl or mono-fluoroalkyl phosphonic acid such as 1H,1H,2H,2H-perfluorooctane phosphonic acid, an alkoxysilane such as a mono- alkoxy silane, e.g., an alkyl, fluoroalkyl and perfluoroalkyl mono- alkoxy silane, trimethylmethoxysilane; a di-alkoxy silane, e.g., a dialkyl di-alkoxy silane, such as a C₁₋₈ dialkyldialkoxy silane e.g., dimethyldimethoxysilane, dimethoxy(methyl)octylsilane, a di-alkoxy, diphenyl silane, diethyldiethoxysilane, diisopropyldimethoxysilane, di-n-butyldimethoxysilane, diisobutyldimethoxysilane, diisobutyldiethoxysilane, isobutylisopropyldimethoxysilane, dicyclopentyldimethoxysilane, a di-alkoxy, fluoroalkyl silane or perfluoroalkyl silane, dimethoxy-methyl(3,3,3-trifluoropropyl)silane, (3,3,3-trifluoropropyl)methyldimethoxysilane, a alkyltrimethoxysilane, a tri-alkoxy silane, e.g., a perfluoroalkyl-tri-alkoxy silane, trimethoxy(3,3,3-trifluoropropyl)silane, trimethoxymethyl silane, 1H,1H,2H,2H-perfluorodecyltrimethoxysilane, 1H, 1H,2H,2H-perfluorodecyltriethoxysilane, nonafluorohexyltrimethoxysilane, nonafluorohexyltriethoxysilane, (tridecafluoro-1,1,2,2-tetrahydrooctyl)trimethoxysilane, tridecafluoro-1,1,2,2-tetrahydrooctyl)triethoxysilane, heptadecafluoro-1,1,2,2-tetrahydrodecyl)trimethoxysilane, (heptadecafluoro-1,1,2,2-tetrahydrodecyl)triethoxysilane, a chlorosilane, e.g., octyldimethylchlorosilane, a dichlorosilane, e.g., diethyldichlorosilane, di-n-butyldichlorosilane, diisopropyldichlorosilane, dicyclopentyldichlorosilane, di-n-hexyldichlorosilane, dicyclohexyldichlorosilane, di-n-octyldichlorosilane, 3,3,3-trifluoropropyl)methyldichlorosilane, nonafluorohexylmethyldichlorosilane, (tridecafluoro-1,1,2,2-tetrahydrooctyl)methyldichlorosilane, (heptadecafluoro-1,1,2,2-tetrahydrodecyl)methldichlorosilane, (3,3,3-trifluoropropyl)dimethylchlorosilane, nonafluorohexyldimethylchlorosilane, tridecafluoro-1,1,2,2-tetrahydrooctyl)dimethylchlorosilane, (heptadecafluoro-1,1,2,2-tetrahydrodecyl)dimethylchlorosilane, a trichlorosilane, e.g., (tridecafluoro-1,1,2,2-tetrahydrooctyl)trichlorosilane, (3,3,3 -trifluoropropyl)trichlorosilane, nonafluorohexyltrichlorosilane, (heptadecafluoro-1,1,2,2-tetrahydrodecyl)trichlorosilane, an amino silane, e.g., nonafluorohexyltris(dimethyamino)silane, etc.

The alkoxy groups of such reactive components can be C₁₋₄ alkoxy groups such as methoxy (—OCH₃), ethoxy (—OCH₂CH₃) groups and the alkyl groups of such reactive components can have various chain lengths, e.g., of C₁₋₃₀, such as C₃₋₃₀. The alkyl groups of such reactive components that form linear polymers generally have a lower alkyl group, e.g., C₁₋₁₆, such as C₁₋₈. The alkyl groups in each case can be substituted with one or more fluoro groups forming fluoroalkyl and perfluoroalkyl groups of C₁₋₃₀, C₃₋₃₀, C₁₋₁₆, C₁₋₈, etc. chains such as a fluoroalkyl or perfluoroalkyl alkoxysilane, a difluoroalkyl or diperfluoroalkyl di-alkoxy silane, a fluoralkyl or perfluoralkyl tri-alkoxy silane having such chain lengths.

The bonded layer can be formed from the formulation by reacting the reactive components of the formulations directly with exposed hydroxyl groups or other reactive groups on the surface of a substrate to form an array of linear compounds having one end covalently bound directly to the surface through the hydroxyl groups or other reactive groups on the surface of a substrate. Alternatively, the bonded layer can be formed by polymerizing one or more of a silane monomer directly from exposed hydroxyl groups or other reactive groups on the surface of a substrate to form an array of linear polysilanes or polysiloxanes or a combination thereof covalently bound directly to the surface through the hydroxyl groups or other reactive groups on the surface of a substrate. Preferably the linear polymers, with one end attached to the surface and the other extending away from the surface, do not form covalent bonds or crosslink with the neighboring linear polymers (e.g., forms brush-like structures).

The bonded layer can have a thickness of less than about 1000 nm. In some cases, the thickness of the bonded layer can be less than about 500 nm, less than about 100 nm or even less than about 10 nm, e.g. from about 1 or 5 nm to about 500 nm.

One or more catalysts can be included in the formulations of the present disclosure. As used herein a catalyst refers to one or more catalysts. A catalyst can facilitate and accelerate formation of the bonding layer. Useful catalysts that can be included in the formulation include, for example, sulfuric acid, hydrochloric acid, phosphoric acid, nitric acid, benzoic acid, acetic acid, ascorbic acid, citric acid, formic acid, lactic acid, oxalic acid, or combinations thereof.

In some embodiments, the catalyst does not include a catalyst containing a transition metal such as platinum since such catalysts tend to increase costs and remain in a formed coating including such catalysts.

The formulation of the present disclosure also includes a solvent, carrier, or medium which can be a single solvent or multiple solvents such as a solvent system, collectively referred to herein as a solvent. A solvent can facilitate formation of the bonding layer and, when the lubricant is present in the formulation, the infusion of the lubricant within the bonding layer during formation of the repellent coating on the surface. Preferably, the solvent should have a relatively low boiling point and relatively high vapor pressure for ease of evaporating the solvent from the formulation when forming the repellent coating therefrom. Solvents with higher boiling points and lower vapor pressure can be used but tend to inhibit the rate of drying and/or may need to be removed by application of a reduced atmosphere to remove the solvent.

Useful solvents that can be included in the formulation of the present disclosure can include one or more of a lower ketone, e.g., a C₁₋₈ ketone such as acetone, methyl ethyl ketone, cyclohexanone, a lower alcohol, e.g., a C₁₋₈ alcohol such as methanol, ethanol, isopropanol, a butanol, a lower ether, e.g., a C₁₋₈ ether such as dimethyl ether, diethyl ether, tetrahydrofuran, a lower ester, e.g., a C₁₋₈ ester such as ethyl acetate, butyl acetate, glycol ether esters, a lower halogenated solvent, e.g., a chlorinated C₁₋₈ such as methylene chloride, chloroform, an aliphatic or aromatic hydrocarbon solvent such as hexane, cyclohexane, toluene, xylene, dimethylformamide, dimethyl sulfoxide and any combination thereof. A solvent can also include a certain amount of water, e.g., less than about 5 wt % of water. In some embodiments, the solvent is a non-volatile organic compound, which can include non-cyclic, low molecular weight siloxanes such as a linear or a branched volatile alkyl siloxane solvent, .e.g., linear or branched volatile methyl siloxanes, and mixtures thereof.

The formulation of the present disclosure can also include a lubricant or combination of lubricants, collectively referred to herein as a lubricant. In addition or in the alternative, a lubricant can be applied to a bonded layer after forming the bonded layer. In either case, when part of the initially applied formulation or applied subsequently, the lubricant preferably forms a lubricant layer stably adhered to the bonded layer. To form a stably adhered lubricant layer to a bonded layer which in turn is formed from the reactive components of the formulation, a lubricant should have strong affinity to the bonded layer and/or the substrate so that the lubricant can fully wet the surface (e.g., result in an equilibrium contact angle of less than about 5°, such as less than about 3°, about 2°, or less than about 1°, or about 0°) and stably adhere on the surface. Further since surfaces of substrates and repellent coating thereon can be subjected to temperatures above 65° C. and/or 100° C., the lubricant preferably has a low vapor pressure under atmospheric pressure. In addition, the lubricant should be mobile in the formed repellent coating and thus it is preferable that the lubricant not substantially react, if at all, with the reactive components in the formulation. A stably adhered lubricant to the bonded layer is believed due primarily to van der Waals forces, not through covalent bonding to the bonding layer. In certain embodiments, lubricants for the present disclosure do not have groups that would react with the reactive components of the formulation.

Further, a stably adherent lubricant is distinct from a lubricant placed on a surface, or modified surface, that does not wet the surface (e.g. forms an equilibrium contact angle of greater than 10°) and/or simply slides off the surface within minutes or shorter periods when the surface is raised to a sliding angle of up to 90°. A lubricant layer stably adhered to a bonded layer is one that substantially remains (greater than about 80%) and covering the bonded layer for at least one hour (or longer periods such as several hours and days and months) even when the surface substrate is at a 90° from horizontal and at a temperature of 25° C. In certain aspects, a stable lubricant layer is one that will not be displaced by a lubricant-immiscible fluid placed on the repellent coating having a lubricant layer.

A lubricant useful for formulations and repellent coatings of the present disclosure should have a sufficient viscosity yet be relatively mobile to facilitate repellence of the coating system at temperatures intended for use with the substrate having the repellent coating. Such temperatures can range from about −50° C. to about 300° C. In addition, the surface of the substrate and repellent coating thereon can be subjected to high temperature cycling of above and below 65° C., e.g. ,above and below 100° C., and the cycle repeated multiple times. As such, a lubricant should preferably have a viscosity of at least about 20 cSt (as measured at 25° C.) such as at least about 30 cSt, 40 cSt, 50 cSt, 60 cSt, 70 cSt, 80 cSt, 90 cSt, 100 cSt, 200 cSt, 300 cSt, 350 cSt, 400 cSt, 500 cSt, 600 cSt, 700 cSt, 800 cSt, 900 cSt, 1000 cSt etc. (as measured at 25° C.) and any value therebetween. Further, so that the lubricant can be mobile at certain temperatures in which the repellent coating can be used, a lubricant should preferably have a viscosity of no more than about 1500 cSt as measured at 25° C., such as no more than about 1,200 cSt, 1,100 cSt, 1,000 cSt, 900 cSt, etc., as measured at 25° C., and any value therebetween. In an embodiment, a lubricant for a formulation of the present disclosure can have viscosity ranging from about 20 cSt to about 1500 cSt, such as from about 20 cSt, 50 cSt, 100 cSt, etc. to about 1500 cSt, 1200 cSt, 1000 cSt, 800 cSt, 350 cSt, 200 cSt, as measured at 25° C., and any value therebetween. For high temperature uses, the repellent coating can have a lubricant with an even higher viscosity at room temperature since the viscosity of such a lubricant would be less at the higher use temperature. Further, lubricant densities of less than about 2 g/cm³ would be preferable at temperature range from 15° C. to 25° C.

A lubricant included in the formulation of the present disclosure can be one or more of an omniphobic lubricant, a hydrophobic lubricant and/or a hydrophilic lubricant. The lubricant can include a fluorinated oil or a silicone oil (such as food grade silicone oil) or a hydroxy polydimethylsiloxane or a mineral oil. Preferable, the lubricant is chosen to have a strong chemical affinity to the particular bonding layer and/or substrate so that the lubricant can fully wet and stably adhere to the surface via the boding layer. For example, perfluorinated oils such as a perfluoropolyether (e.g., Krytox oil) can fully wet and stably adhere to a polymeric siloxane and/or silane bonding layer including fluorinated alkyl silanes such as perfluorinated alkyl silanes. Such a bonding layer can be formed from reactive fluoroalkyl silanes in a formulation that reacts with functional groups on a surface of a substrate. Silicone oil, such as food grade silicone oil having a viscosity from about 300-350 cSt to about 1,000 cSt can fully wet and stably adhere to a bonded layer comprised of an array of linear polydimethylsiloxane (PDMS), for example. Hydroxy PDMS can also fully wet and stably adhere to a bonded layer comprised of an array of linear polydimethylsiloxane, for example. Such a PDMS bonding layer can be formed from polymerizing dimethyldimethoxysilane from a surface of a substrate. Mineral oils can fully wet and stably adhere to a bonding layer including an array of alkyl silanes which can be formed from alkyltrichlorosilanes or alkyltrimethoxysilanes. The alkyl groups on such alkylsilanes can have various chain lengths, e.g., alkyl chains of C₁₋₃₀. Other lubricants that will be compatible with alkylsilanes with various chain lengths and polysiloxanes polymerized from one or more dialkyldialkoxysilanes such as dimethyldimethoxysilane include alkane oils.

In certain embodiments, the concentrations of various components on a weight bases in formulations of the present disclosure can include the ranges provided in the tables below:

TABLE 1A
Formulations without lubricant

| Component | Approximate Concentration Range |
|---|---|
| Reactive component(s) | 1-20 wt % |
| Solvent | 78-99 wt % |
| Acid Catalyst | 0.01-2 wt % |

TABLE 1B
Formulations without lubricant

| Component | Approximate Concentration Range |
|---|---|
| Reactive component | 1-20 wt % |
| Solvent | 65-97 wt % |
| Acid Catalyst | 2-15 wt % |

TABLE 2A
Formulations with lubricant

| Component | Approximate Concentration Range | |
|---|---|---|
| Reactive component(s) | 1-20 | wt %, |
| Solvent | 28-99 | wt %, |
| Acid Catalyst | 0.01-2 | wt % |
| Lubricant | 0.05-50 | wt % |

TABLE 2B
Formulations with lubricant

| Component | Approximate Concentration Range | |
|---|---|---|
| Reactive component | 1-20 | wt %, |
| Solvent | 15-97 | wt %, |
| Acid Catalyst | 2-15 | wt % |
| Lubricant | 0.05-50 | wt % |

Other components can be included in the formulations of the present disclosure such as a fragrance, i.e., a substance that emits a pleasant odor, and/or a masking compound, i.e., a substance that masks the odors of other ingredients. A fragrance includes, for example, a natural or synthetic aroma compound or an essential oil such as a lemon oil, bergamot oil, lemongrass oil, orange oil, coconut oil, peppermint, oil, pine oil, rose oil, lavender oil or any combination of the foregoing. As an example, the fragrance added to the formulation of the present disclosure can have a smell of lemon, or rose, or lavender, or coconut, or orange, or apple, or wood, or peppermint, etc. One or more fragrance or masking compound can be added to a formulation of the present disclosure as is, e.g., without dilution, and can be added in a range of about 0.0005 parts to about 10 parts, e.g. from about 0.01 to about 5 parts, by weight in place of the solvent. In certain aspects, the fragrance and/or masking compound is soluble in alcohols and siloxanes.

Repellent coatings prepared from formulations of the present disclosure can repel and resist adherence of broad range of liquids and solids including but not limited to water, soapy water, hard water, minerals, plastics, debris, bacteria, residues, such as residue from food stuffs, dairy products, proteins, fats, yeast, biological fluids, etc.

In practicing certain aspects of the present disclosure, it is preferable to form a repellent coating on a substrate with a relatively smooth surface. In some embodiments, the substrate surface has an average roughness (Ra) at a microscale level, e.g., Ra of less than a few microns, and preferably less than a few hundred nanometers, or even less than a few nanometers. Advantageously, the surface of a substrate to which a repellent coating is to be formed thereon is relatively smooth, e.g., the surface has an average roughness Ra of less than about 4 μm, e.g., less than about 2 μm and less than about 1 μm average surface roughness and even less than about 500 nm, e.g., less than about 100 nm, 80 nm, 60 nm, 40 nm 20 nm, 10 nm, etc. average surface roughness.

Average surface roughness can be measured by atomic force microscope (AFM) using tapping mode with a scanning area of 2×2 μm² for measuring average surface roughness in a 0.1-nanometer scale or equivalent technique. Average surface roughness can be measured by Zygo optical profilometer with an area of 100×100 μm² to 500×500 μm² for measuring average surface roughness in a 1-nanometer scale or equivalent technique.

In practicing certain aspects of the present disclosure, the surface of the substrate can be treated to form reactive groups thereon such as hydroxyl groups, such as by applying and removing an alcohol, by oxygen plasma treatment, or by heating under the presence of air or oxygen (for surfaces comprising metals, for example). The substrate can include a reactive coupling layer and the repellent coating formed on the surface of the coupling layer.

The substrate surface can be cleaned (removal of debris such as residues on the substrate surface) and dried before applying a formulation. One example for cleaning a substrate surface involves the use of a lower alcohol, e.g., ethanol or isopropanol, to clean the surface. Then, the surface can be optionally dried. The formulation is then applied on to the cleaned surface.

Further, it was discovered that the formulation itself can also serve to clean surfaces (remove debris such as residue on the substrate surface) as well as to form repellent coatings on surfaces. The effectiveness of a formulation of the present application to act as a cleaner depends, in part, on the solvent included in the formulation. Lower alcohols, e.g., ethanol, isopropyl alcohol, 1-propanol, etc., and lower ketones, e.g., acetone, methylethyl ketone, etc., serve as a good solvent to remove debris and residue including baked and burnt food residues.

In certain aspects, the solvent in the formulation of the present disclosure comprises one or more of a lower ketone, lower alcohol, lower ether, lower ester, lower halogenated solvent, dimethylformamide, dimethyl sulfoxide and combinations thereof as at least 50 wt %, e.g., in at least 80 wt % of the total amount of the solvent. In certain embodiments, the solvent comprises as at least 90 wt %, 95 wt %, 97 wt %, 99 wt % and up to 100% of the forgoing solvents with only trace amounts, if any, of other solvents.

Hence, in another aspect of the present disclosure, a substrate surface, either having a repellent coating or without such a repellent coating, can be cleaned, e.g., have debris and/or residues removed, with a formulation of the present application. The process can advantageously include cleaning and forming a repellent coating on a surface of a substrate that has debris and/or residue thereon (e.g., from foods, biological fluids, etc.) by applying formulations of the present disclosure on the surface to remove the debris and/or residue thereon. The formulations can be applied under pressure (e.g., greater than 101 kPa, such as greater than about 200 or about 300 kPa) and under heat (e.g., greater than 35° C. such as from 35° C. to about 100° C.), which is advantageous in closed systems such as in heat exchangers and tanks. The formulations can also be circulated, with or without heat and/or pressure, which is advantageous in closed systems. Additional formulation can then be applied, if needed, on the cleaned surface prior to drying the formulation on the surface of the substrate to substantially remove the solvent and to form the repellent coating on the surface. Cleaning surfaces of substrates with formulations of the present disclosure advantageously facilitates repair or replacement of any damaged repellent coating resulting from high temperatures or high temperature cycling or chemical damage or physical abrasions.

Processes for preparing a repellent coating on a surface of a substrate includes drying a formulation of the present disclosure on a surface of a substrate to substantially remove the solvent, e.g., greater than about 60%, 65%, 70%, 80%, 85%, 90%, 95%, 99% by weight and higher of the solvent can be removed in the drying step. Drying the formulation concentrates the reactive components and causes them to react to form a bonded layer on the surface of the substrate. The reactive components are chosen such that they react with the surface to form an array of compounds each having one end bound to the surface and an opposite end extending away from the surface. Drying the formulation also causes the lubricant to be concentrated and retained within the bonded layer. The lubricant is thus chosen to have an affinity for the bonded layer and/or surface so that it can form a lubricant layer stably adhered to the surface via the bonded layer.

Repellent coatings on a surface of a substrate can advantageously be formed by drying under relatively low temperatures, e.g., temperatures ranging from about 0° C. to about 80° C. Hence, forming the repellent coating from formulations of the present disclosure can be carried out at from about 5° C. to about room temperature, e.g., 20° C., and at an elevated temperature, e.g., greater than about 25° C., 30° C., 40° C., 50° C., 55° C., 60° C., 70° C., 80° C., etc. Forming the repellent coating can also be advantageously carried out in a relatively short period of time such as in a period of no more than about 120 minutes such as 60 minutes, e.g., no more than about 30 minutes, and no more than 20 minutes, and no more than 10 minutes, and even as short a period of no more than about 5 minutes and no more than about 3 minutes and even no more than 1 minute. Although a vacuum could accelerate drying of the formulation, it is not necessary for the process and drying of formulations of the present disclosure can be carried out at atmospheric pressure, e.g., at about 1 atm. Further, drying and/or applying the formulation of the present disclosure can be carried out in air or in an inert atmosphere, e.g., a nitrogen atmosphere.

Applying formulations of the present disclosure on to a surface of a substrate can be carried-out with liquid-phase processing thereby avoiding complex equipment and processing conditions. Such liquid-phase processing includes, for example, simply submerging the substrate (dip-coating) or applying the formulation on to the substrate surface by wiping, spraying (including aerosol spray), curtain coating and/or spin coating the formulation on to the surface. Other methods of applying formulations of the present disclosure on to a surface of a substrate can be carried out by wiping a towel made of a fabric, paper or similar material, or a sponge or squeegee, infused with the formulation, on the surface to transfer the formulation from the towel, sponge, squeegee to the surface of the substrate. Advantageously, the formulation can be applied to the substrate surface under ambient temperatures and/or atmospheric pressures and in air, e.g., formulations of the present disclosure can be applied on surfaces of substrates in air and at atmospheric pressure. In certain embodiments, the formation of the bonded layer is accelerated in the presence of a catalyst, e.g., an acid catalyst, and water. The water can be either available from the solvent or from the atmosphere or both. Drying the formulation in an atmosphere having some moisture, e.g., an ambient humidity of at least about 10% at 20° C. and atmospheric pressure is preferable from certain of the reactive components. Hence in some embodiments, the formulation of the present disclosure is dried at an ambient humidity of from about 10% to no more than about 80%.

Forming the repellent coating by applying and drying a formulation of the present disclosure can be advantageously carried out in a relatively short period of time such as in a period of no more than about 120 minutes such as 60 minutes, e.g., no more than about 30 minutes, and no more than 20 minutes, and no more than 10 minutes, and even as short a period of no more than about 5 minutes and no more than about 3 minutes and even no more than 1 minute. Further, drying and/or applying the formulation of the present disclosure can be carried out in air or in an inert atmosphere, e.g., a nitrogen atmosphere, and at atmospheric pressure. Advantageously, the repellent coating can be formed on substrate surfaces under ambient conditions (e.g., in air under about one atmosphere of pressure and at temperatures from about 5° C. to about 40° C.). In some embodiments, the repellent coating can be formed on substrate surfaces at temperatures from about 5° C. to about 75° C.

In some instances and under certain conditions, the lubricant layer of the repellent coating can be depleted over time. Advantageously, the lubricant layer can be replenished by applying lubricant, either the same or a different lubricant than used to prepare the repellent coating, to the bonded layer to renew the repellent coating system on the surface of the substrate. The applied lubricant can be in undiluted form when applied to the bonded layer or diluted with medium when applied to the bonded layer. The medium can include water, one or more of a lower ketone, e.g., a C₁₋₈ ketone such as acetone, methyl ethyl ketone, cyclohexanone, a lower alcohol, e.g., a C₁₋₈ alcohol such as methanol, ethanol, isopropanol, a butanol, a lower ether, e.g., a C₁₋₈ ether such as dimethyl ether, diethyl ether, tetrahydrofuran, a lower ester, e.g., a C₁₋₈ ester such as ethyl acetate, butyl acetate, glycol ether esters, a lower halogenated solvent, e.g., a chlorinated C₁₋₈ such as methylene chloride, chloroform, an aliphatic or aromatic hydrocarbon solvent such as hexane, cyclohexane, toluene, xylene, dimethylformamide, dimethyl sulfoxide and any combination thereof

The lubricant can be diluted in the medium in which the medium comprises from about 1 wt % to about 99 wt % of a mixture of the medium with the lubricant. The range of dilution can depend on the medium. For example, a water medium can be used from about 1 wt % to about 70 wt % and an alcohol medium such as isopropanol can be used from about 1 wt % to about 99 wt %. The lubricant can be applied to the bonded layer, undiluted or diluted, and by dip-coating, wiping, spraying (including aerosol spray), etc.

An exemplary formulation of the present disclosure can include one or more polymerizable silane monomers and/or siloxane monomers as the reactive component, an acid catalyst, e.g., HCl, phosphoric acid, acetic acid, and a solvent. Drying such a formulation polymerizes the monomers from exposed hydroxyl groups on the surface of the substrate to form an array of linear polysilanes or polysiloxanes or a combination thereof. By this technique, the array of linear polymers have ends covalently bound to the surface and opposite ends extending away from the surface and resemble a brush.

### EXAMPLES

### Example 1

### High Temperature Cycling

For these experiments, glass slides were used as substrates such glass slides can be obtained from McMaster-Carr as 25 mm×75 mm microscope slides. The glass slides were cleaned by isopropanol. Formulations having the components and concentrations provided in Table 3 or Table 4 were applied to different glass slides by dip coating.

TABLE 3
(Formulation 2)

| Component | Approximate Concentration |
|---|---|
| Reactive Monomer: Dimethoxy dimethylsilane | 9.0 wt % |
| Solvent: Isopropyl alcohol | 89.0 wt % |
| Acid Catalyst: Sulfuric acid | 1.0 wt % |
| Lubricant: Silicone oil, 350 cSt food grade | 1.0 wt % |

TABLE 4
(Formulation 1)

| Component | Approximate Concentration |
|---|---|
| Reactive Monomer: | 10.0 wt % |
| Dimethoxy dimethylsilane | |
| Solvent: | 89.0 wt % |
| Isopropyl alcohol | |
| Acid Catalyst: | 1.0 wt % |
| Sulfuric acid | |

After application of a formulation to a glass slide, the formulation was then dried under ambient condition (e.g., 23° C., 60% relative humidity, atmospheric pressure) for 5 minute to form a repellent surface on the glass slides. Subjecting the formulations to these drying conditions resulted in the dimethyldimethoxysilane monomer to polymerize by an acid-catalyzed condensation process to form an array of linear polysiloxanes bound to the glass surface. For the formulation including the lubricant (Table 3, Formulation 2), the silicone oil was stably entrenched within the polysiloxane polymers bonding layer.

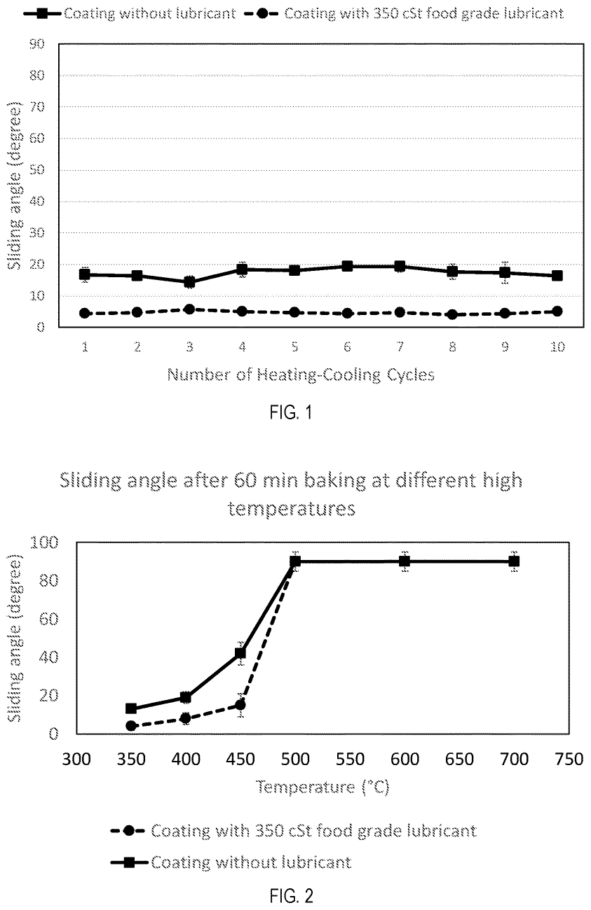

FIG. 1 is a plot showing sliding angles as a function of the high temperature cycles for samples having repellent coatings prepared from the formulations of Table 3 and Table 4. For these experiments, samples were subjected to high temperatures in an oven. The samples were heated to about 280° C. (about 536° F.) per cycle. In each cycle, samples were heated for 30 minutes and then cooled down to room temperature (approximately 20° C.) before taking a sliding angle measurement. Sliding angles were measured by placing a 20 μL water droplet on the coated surface of the substrate. The water used for the measurements was deionized. The substrates were subsequently tilted gradually from a horizontal position until the water droplet began to slide off the substrate. The angle (formed between horizontal and the flat tilted substrate) at which the water droplet began to slide was taken as the sliding angle. At least three sliding contact angle measurements were made and the averaged sliding contact angle was recorded for each data point in FIG. 1.

Samples having coatings formed from the formulations of either Table 3 or Table 4 generated repellent surfaces that exhibited relatively low sliding angles against 20 μL water droplets. The coatings formed from the formulation of Table 4 (Formulation 1, without lubricant) showed sliding angles of no more than about 20° whereas coatings formed from the formulation of Table 3 (Formulation 2, with lubricant) showed sliding angles of less than about 10° . In addition, the low sliding angles were maintained after 10 high temperature cycles of heating to about 280° C. and cooling to about 20° C.

These examples show that substrates including repellent coatings on a surface thereof prepared according to aspects of the present disclosure show the repellent coatings withstood high temperature cycles while maintaining their repellency.

### Example 2

### High Temperature Stability

For these experiments, high-temperature glass ceramics (obtained from McMaster-Carr) were used as substrates. The glass ceramic slides were cleaned by isopropanol. Formulations having the components and concentrations provided in Table 3 (formulation with lubricant) or Table 4 (formulation without lubricant) were applied to different glass ceramic slides by dip coating.

After application of the formulations to the glass ceramic slides, the formulations were then dried under ambient conditions (e.g., 23° C., 60% relative humidity, atmospheric pressure) for 5 minutes to form repellent coatings on the glass ceramic slides. Subjecting the formulations to these drying conditions resulted in the dimethyldimethoxysilane monomer to polymerize by an acid-catalyzed condensation process to form an array of linear polysiloxanes bound to the glass surface. For the formulation including the lubricant (Table 3, Formulation 2), the silicone oil was stably entrenched within the polysiloxane polymers bonding layer.

FIG. 2 is a plot showing sliding angles as a function of high temperature treatment. For these experiments, samples were subjected to high temperature in an oven. Samples were heated to a certain temperature and held at that temperature for 60 minutes. Then the temperature was reduced to about 200° C. quickly by shutting down the oven and opening the oven door. Afterwards, the samples were removed from the oven to further cool the samples down to room temperature (approximately 20° C.) before taking a sliding angle measurement. Sliding angles were measure by placing a 20 μL water droplet (deionized) on the coated surface of the substrate as described for Example 1. At least three sliding contact angle measurements were made and the averaged sliding contact angle was recorded for each data point of FIG. 2.

The data from these examples show that substrates including repellent coatings on a surface thereof prepared from formulations according to aspects of the present disclosure can withstand temperatures in excess of about 300° C. while maintain repellency as shown by a sliding contact angle of less than about 20° . The data in FIG. 2 further shows that repellent coatings having a stably adhered lubricant layer to the bonded layer have lower sliding contact angles and can withstand higher temperatures, e.g., up to about 400° C.

### Example 3

### Extended High Temperature Stability

The high temperature stability of repellent coatings formed from formulations according to the present disclosure can be extended by shielding the surface of the coating from direct contact with air. For this experiment, repellent coatings on glass ceramic samples were prepared as in Example 2 using Formulation 1 (Table 4) or Formulation 2 (Table 3). A coated glass ceramic sample was then covered by placing another glass ceramic slide on top of the coated surface so that the top coated surface was not exposed to air directly (i.e., a protected surface).

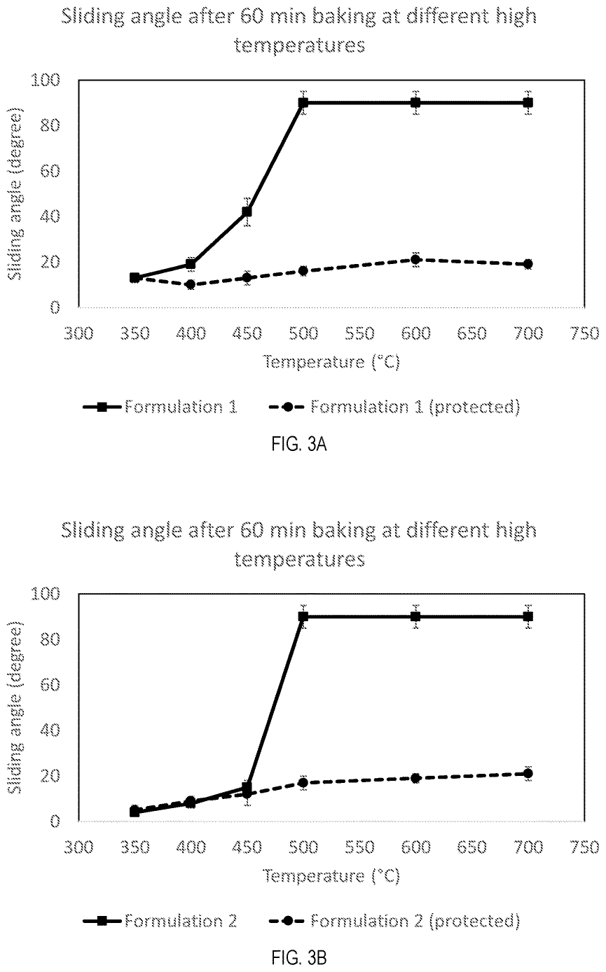

Such samples with protected surfaces were then placed in an oven at various temperatures and compared to repellent coated glass ceramic slides prepared from the formulations but with an exposed coated surface, i.e., without another glass ceramic slide on top of the coated surface so that the top coated surface was exposed to air. The samples were heated to the temperatures shown in FIGS. 3A and 3B and held at the particular temperature for 60 minutes. Then the samples were cooled down by the procedure described for Example 2.

Sliding angles were measure by placing a 20 μL water droplet (deionized) on the coated surface of the substrate as described for Example 1. For FIGS. 3A and 3B, any sliding angle measurement of equal to or larger than 90 degrees (i.e., not sliding) were plotted as 90 degrees. All error bars represent standard deviations of at least 3 independent measurements.

The data in FIG. 3 show that a low sliding angle (repellent coating) can be maintained at extremely high temperatures, up to 700° C., when the repellent coating is shielded from direct exposure to air.

### Example 4

### Repellency After High Temperatures and Cleaning Characteristics

Formulations of the present application provide low adhesion after subjected to high temperatures. For the following experiments, certain burnt food residues were created by depositing drops of proteins (e.g., egg yolk) or an edible oil on to substrate surfaces that either had a repellent coating already formed from Formulation 2 or Formulation 1 (Table 3 or 4, respectively) on the substrate surface or on substrate surfaces without such a repellent coating. The substrates used for these experiments were glass slides obtained from McMaster-Carr (25 mm×75 mm microscope slides). After depositing the egg yolk or vegetable oil onto the substrate surfaces, the substrates were heated to 218° C. (425° F.) for 1 hour to form the burnt food residue on to coated or uncoated substrate surfaces. Then the samples were cooled down to room temperature.

A series of cleaning methods were then applied to clean the surfaces with burnt residues formed thereon. These cleaning methods were progressively more aggressive and required more effort and time. The result of a cleaning method was marked with ‘X’ if the cleaning method did not remove substantially all of the residues tested and marked with ‘O’ if substantially all of the residues were removed by the particular cleaning method. Four cleaning methods were used for these experiments, which included: (1) wiping with a paper towel wetted with water; (2) apply either Formulation 1 or Formulation 2 to the substrate and then wiping with dry paper towel; (3) apply a commercially available glass cleaner which contains abrasives followed by scrubbing with a nylon cleaning pad and then wiping with a dry paper towel; (4) initially scraping the residues with a nylon scraper followed by the procedure of method (3).

Tables 5 and 6 below show the results of cleaning uncoated substrates with burnt residues formed thereon and substrates having a repellent coating formed from Formulation 1 or 2 prior to forming burnt food residues thereon.

TABLE 5
Cleaning Substrates with burnt egg yolk residue

| 42° F./ 218° C. | | | Substrate Surface | | |
|---|---|---|---|---|---|
| 1 hour | | Cleaning | | Formulation | Formulation |
| Egg yolk | | method | Uncoated | 1 | 2 |
| Increasing | ↓ | 1. Paper towel | X | X | O |
| effort | ↓ ↓ | 3. Commercial abrasive cleaner | O | O | O |

TABLE 6
Cleaning Substrates with burnt vegetable oil residue

| 425° F./ 218° C. 1 hour | | | Substrate Surface | | |
|---|---|---|---|---|---|
| Vegetable oil | | Cleaning | | Formulation | Formulation |
| drops | | method | Uncoated | 1 | 2 |
| Increasing | ↓ | 1. Paper towel | X | O | O |
| effort | ↓ ↓ | 3. Commercial abrasive cleaner | X | O | O |

The results provided in Tables 5 and 6 show that surfaces having a repellent coating formed from Formulation 1 or Formulation 2 were more easily cleaned than an uncoated substrate surface, which shows the repellent coatings formed from the formulations of the present disclosure exhibited low adhesion to the burnt food residues even at high temperatures. The data of Tables 5 and 6 further show that surfaces having a repellent coating formed from formulations according to the present disclosure having certain burnt food residue thereon could be readily removed by simply wiping off the residue with a water wet paper towel. Repellent coatings having a lubricant layer adhered thereon exhibited lower adhesion to certain burnt food residue than without the lubricant layer as shown by the results of Tables 5-6.

In addition, formulations of the present application can also serve to clean surfaces as well as to form repellent coatings on surfaces. For the following experiments, a vegetable oil was deposited on to substrate surfaces that either had a repellent coating already formed from Formulation 2 or Formulation 1 (Table 3 or 4, respectively) on the substrate surface or on substrate surfaces without such a repellent coating followed by heating the substrates 218° C. (425° F.) for 2 hours to form burnt vegetable oil residue on substrate surfaces. Heating the substrates for 2 hours rather than the 1 hour as in the previous experiment forms a burnt residue that is more challenging to remove.

Table 7 below shows the results of cleaning uncoated and coated substrates with burnt vegetable oil residues formed thereon with various cleaning methods.

TABLE 7
Cleaning Substrates having burnt vegetable oil residue by various methods with coated and uncoated substrates.

| 425° F./ 218° C. 2 hour | | | Substrate Surface | | |
|---|---|---|---|---|---|
| Vegetable oil | | Cleaning | | Formulation | Formulation |
| drops | | method | Uncoated | 1 | 2 |
| Increasing | ↓ | 1. Paper towel | X | X | X |
| effort | ↓ ↓ | 2. Coating formulation (Formulation 2) | X | O | O |
| | | 3. Commercial abrasive cleaner | X | X | X |
| | | 4. Scraper + abrasive cleaner | X | O | O |

Table 7 shows that the coating formulation itself can be used as a cleaner to remove burnt food residue and that residue removal can be easier with formulations of the present application than with a commercial cleaner. Additionally, any damaged repellent coating resulting from high temperatures or high temperature cycling can be replenished by formulations of the present application during the cleaning process.

Only the preferred embodiment of the present invention and examples of its versatility are shown and described in the present disclosure. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific substances, procedures and arrangements described herein. Such equivalents are considered to be within the scope of this invention, and are covered by the following claims.

What is claimed is:

1. A substrate comprising a repellent coating on a surface thereof, wherein the repellant coating is formed from a formulation comprising: (i) one or more dialkyl di-alkoxy silane reactive components that can form a bonded layer on the surface in which the bonded layer comprises an array of compounds each compound having one end bound to the surface and an opposite end extending away from the surface, (ii) an acid catalyst, and (iii) a solvent; and
wherein the surface of the substrate and repellent coating thereon are subjected to a temperature of above and below 65° C. as a cycle and the cycle repeated at least twice.

2. The substrate of claim 1, wherein the repellent coating on the surface of the substrate is at a temperature of above 100° C. for at least 10 minutes.

3. The substrate of claim 1, wherein the one or more dialkyl di-alkoxy silane reactive components comprises dimethyldimethoxysilane.

4. The substrate of claim 1, wherein the formulation further comprises (iv) a lubricant, wherein the lubricant is a food grade silicone oil having a viscosity from about 300 cSt to about 1,000 cSt when measured at 25° C.

5. The substrate of claim 1, wherein the repellant coating further includes a lubricant layer stably adhered to the bonded layer.

6. The substrate of claim 1, wherein the surface of the substrate and repellent coating thereon are subjected to a temperature of above and below 100° C. as a cycle and the cycle repeated at least twice.

7. The substrate of claim 1, wherein after the cycles, the surface of the substrate has an average sliding contact angle for a 20 μL water droplet of no more than about 35° when measured at 20° C.

8. The substrate of claim 1, wherein the surface of the substrate comprises a glass, glass-ceramic, porcelain, metal or a combination thereof.

9. A stove or heat exchanger having the repellent coating on a surface thereof of claim 1.

10. A process of using the substrate according to claim 8, the process comprising:
repeating the cycle of subjecting the surface of the substrate and repellent coating thereon to the temperature at least three times.

11. A process of forming a repellent coating on a surface of a substrate from a formulation, the process comprising:
drying a formulation on a surface of a substrate to substantially remove a solvent and to form a repellent coating on the surface; and
after forming the repellent coating, subjecting the surface of the substrate and repellent coating thereon to a temperature of above and below 65 ° C. as a cycle and repeating the cycle at least twice;
wherein the formulation comprises: (i) one or more low molecular weight silane or siloxane reactive components that can form a bonded layer on the surface in which the bonded layer comprises an array of compounds each compound having one end bound to the surface and an opposite end extending away from the surface, (ii) an acid catalyst, and (iii) a solvent, provided the array of compounds formed from the reactive compounds are not crosslinked.

12. The process of claim 11, further comprising applying a lubricant to the bonded layer to form a lubricant layer stably adhered to the bonded layer, wherein the lubricant is a silicone oil having a viscosity of at least about 20 cSt when measured at 25° C.

13. The process of claim 11, wherein the formulation further comprises (iv) a lubricant, wherein the lubricant is a silicone oil having a viscosity of at least about 20 cSt when measured at 25° C.

14. The process of claim 11, wherein the formulation is dried in air and at atmospheric pressure.

15. A process of cleaning and forming a repellent coating on a surface of a substrate, the process comprising:
applying a formulation on a surface of a substrate that has residue thereon to remove the residue from the surface;
drying the formulation on the surface of the substrate to substantially remove the solvent and to form a repellent coating on the surface; and
after forming the repellent coating, subjecting the surface of the substrate and repellent coating thereon to a temperature of above and below 65° C. as a cycle and repeating the cycle at least twice;
wherein the formulation comprises: (i) one or more low molecular weight silane or siloxane reactive components that can form a bonded layer on the surface in which the bonded layer comprises an array of compounds each compound having one end bound to the surface and an opposite end extending away from the surface, (ii) an acid catalyst, and (iii) a solvent.

16. The process of claim 15, wherein the solvent comprises one or more lower alcohols in at least 80 wt % of the total amount of the solvent.

17. The process of claim 15, wherein the one or more reactive components comprises one or more dialkyl di-alkoxy silane reactive components.

18. The process of claim 15, wherein the formulation further comprises (iv) a lubricant, wherein the lubricant is a food grade silicone oil having a viscosity from about 300 cSt to about 1,000 cSt when measured at 25° C.

19. The process of claim 15, wherein the surface of the substrate that has residue thereon is a surface of a stove or a heat exchanger.

20. The process of claim 15, further comprising, after forming the repellent coating, applying a lubricant to the repellent coating.
